(19) United States
(12) Patent Application Publication
(10) Pub. No.: US 2003/0214957 A1
(43) Pub. Date: Nov. 20, 2003

(54) Broadband set-top box front-end storage system

(76) Inventors: Matthew John Wahoske, Indianapolis, IN (US); Thomas Herbert Jones, Westfield, IN (US); Xiaodong Liu, Carmel, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/146,431

(22) Filed: May 15, 2002

(51) Int. Cl. H04L 12/28

(52) U.S. Cl. 370/401

(57) ABSTRACT

A user-side receiver system includes a gateway device, which provides an interface between a subscriber-based network, and an output device. A storage system is disposed externally from the gateway device and is coupled to the gateway device through a network interface. The storage system provides memory for storage of data streams transmitted from the network to the gateway device. The network interface links the gateway device to the storage system to cooperatively access and store data to/from the storage system in a way that limits access to the data by a user.

### FIELD OF THE INVENTION

The present invention generally relates to storage systems and, more particularly, to a method and system for mass storage including a gateway device connected by a home networking technology interface to storage media located on a separate computer device.

### BACKGROUND OF THE INVENTION

The use of hard drives as a storage device, especially for video, has become increasingly common after the introduction of Personal Video Recorder (PVR) technology. As a result, many current PVR's and set-top box devices include a hard drive as part of the device. This introduces an added cost to the device that makes the box less financially desirable.

Therefore, a need exists for a method and system, which reduces the cost of set top boxes by obviating the need to provide internal storage devices and management controls. A further need exists for a more economical set top box to make these devices more financially desirable.

### SUMMARY OF THE INVENTION

A user-side receiver system includes a gateway device, which provides an interface between a subscriber-based network and an output device. A storage system is disposed externally from the gateway device and is coupled to the gateway device through a network interface. The storage system provides memory for storage of data streams transmitted from the network to the gateway device. The network interface links the gateway device to the storage system to cooperatively access and store data to/from the storage system in a way that limits access to the data by a user.

A method for receiving and storing data from a subscriber-based network, includes the steps of providing a gateway device which provides an interface between a subscriber-based network and an output device, and a storage system disposed externally from the gateway device and being coupled to the gateway device through a network interface. The storage system provides memory for storage of data streams transmitted from the network to the gateway device. The gateway device is interfaced with the storage device by employing a networking protocol. A data stream is received through the gateway device from the network pursuant to a user's order. The data stream is stored on the storage device for future or concurrent access.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a block diagram of a system architecture for a user-side receiver in accordance with one embodiment of the present invention; and

FIG. 2 is a flow diagram showing an implementation of the storage system and gateway device in accordance with an embodiment of the present invention.

It should be understood that the drawings are for purposes of illustrating the concepts of the invention and are not necessarily the only possible configuration for illustrating the invention.

### DETAILED DESCRIPTION OF THE INVENTION

The present invention provides a system and method for more efficiently employing available memory resources. Many potential consumers of video storage devices, such as set top boxes, own personal computers (PC's) or other devices with high storage capacity hard drives. The present invention replaces hard drives on the set top box or similar device by utilizing existing storage capacity on, say, a PC. By making a connection to the PC, the set top box, for example, would be more economically attractive to potential purchasers or subscribers.

The present invention employs an interface between a gateway device, e.g., a set top box, and the PC. This may include a home networking program or a similar type of interface that is used to connect the gateway device to the PC's hard drive. The interface, for example, is capable of providing a reliable throughput, fast enough to transfer data at an acceptable rate to the consumer (e.g., about 20 Mb/s).

It is to be understood that the present invention is described in terms of a video-on-demand (VoD) system; however, the present invention is much broader and may include any digital multimedia document transfer and storage system, which is capable of delivering digital documents over a switched network. In addition, the present invention is applicable to any system ordering method including orders taken by telephone, set top boxes, computer, satellite links, etc. The present invention is described in terms of a DSL network; however, the concepts of the present invention may be extended to cable, wireless or other network types using ATM technology, for example.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

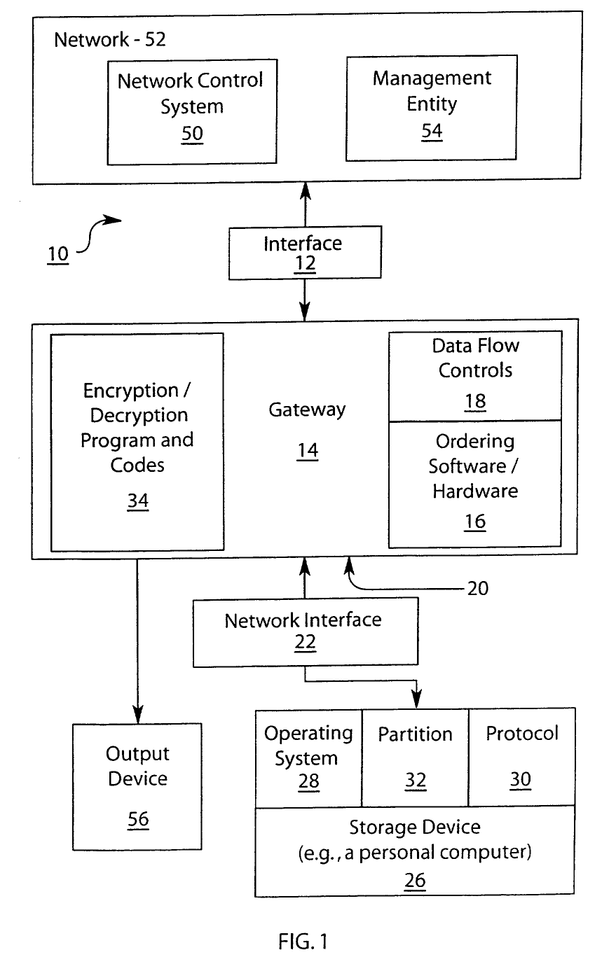

Referring now in specific detail to the drawings in which like reference numerals identify similar or identical elements throughout the several views, and initially to FIG. 1, a portion of a data delivery architecture or user-side receiver system 10 is shown in accordance with one embodiment of the present invention. Architecture 10 may be part of a digital subscriber line (DSL) network or cable network, which may integrate voice, data and video services. Architecture 10 may also be included as part of other document delivery networks, for example, a satellite network or wireless network. Details of the individual components making up the system architecture, which are known to skilled artisans will only be described in details sufficient for an understanding of the present invention.

A connection 12 includes an interface terminated by a gateway device 14. In one embodiment, gateway device 14 may include a set-top box for a cable network or a DSL network. Gateway device 14 may be connected to a cable network, a telephone network, A DSL network, a satellite network, a wireless network or any other network suitable for transmitting data. Gateway device 14 may include data ordering hardware/software 16 and data flow controls 18. Data flow controls 18 may be employed, for example, in an application such as video-on-demand ordering, for rewinding, fast-forwarding, pausing, etc. an ordered video.

Advantageously, gateway device 14 does not need to provide memory storage capabilities, although gateway device may include such storage capabilities. Instead, gateway device 14 includes an interface port 20. Interface port 20 may include a coaxial connector, 1394-fire wire or other high-speed connection interface/wire 22.

Connection 22 links or connects gateway device 14 to a mass storage device 26 located at the customer's premises. Mass storage device 26 preferably includes a personal computer, although a database or other storage system may be employed. Mass storage device 26 preferably includes processing capabilities so that software programs can be run thereon. Device 26 may include an operating system 28 on which an interface program/protocol 30 is implemented. Protocol 30 is employed to permit communication between gateway device 14 and storage device 26. Protocol 30 works with a home networking technology, such as HPNA (Home Phoneline Networking Alliance) or a similar type of interface 22, to provide an interface to hard drive(s) or storage devices on storage device 26. The hard drive(s) are used to store applications and/or data from gateway device 14 (e.g. video, plug-ins, etc.) instead of employing a hard drive on the gateway device itself.

Use of a hard drive on storage device 26 also enables a data provider serving gateway device 14 to provide applications that support operating systems that are not present on gateway device 14. For example, gateway device 14 may utilize an embedded Linux Operating System (OS), but the user may own a WINDOW's PC. In this case, the data provider can supply WINDOW's based applications without having to include this OS on the gateway device. A similar example can be made for any OS that may be used by the consumer.

As stated above, current implementations of hard drives often place them within the PVR and set-top box device itself and not on a separate PC. The disadvantage in this is the increased cost of the device and the limitation of applications to those written for the specific OS provided by the device.

The present invention permits the hard drive to be located on a separate storage device 26, e.g., a PC, connected to gateway device 14, preferably through an HPNA or a similar type of interface 22, resolving the problems of the prior art implementations.

In one embodiment, installation of storage device 26 may include the installer setting up a specific partition 32 of the hard drive(s) of the consumer's PC for the data needed for the system. Data on this partition may be made unavailable to the consumer. Only the gateway device would be able to read and write to this partition 32. Only after the consumer removes the gateway device and reformats the partition (removing all data currently present on the partition) would that portion of the hard drive become available once more.

In addition, the consumer's PC should be protected from outside users of the gateway's data path. As part of the installation, software may be installed on the PC to facilitate interfacing with the gateway device, as described above. Copy protection may be needed to protect data sent to and stored on the hard drive, especially video data. This data can be encrypted while located on the PC's hard drive and only unencrypted within gateway device 14 to prevent unauthorized copying of the data.

To this end, gateway device 14 may include an encryption/decryption program 34 to encrypt data sent to device 26 and decrypt the data for viewing or usage. The encryption process may preferably be performed by employing keys or codes not known to the end user but know by the data provider. In this way, the data provider can monitor usage and control access to the underlying data. The data provider may therefore be able to erase data from the designated areas of the hard drive of storage device 26 or limit the number of accesses to a given file. In addition, a video or file can “time out” so that an additional fee can be charged for the video if a user desires to view the video or file again after the time out period. By limiting access to the data files while resident on the storage device 26, users may be billed for access to the files since the files can only be accessed after decryption in gateway device 14.

The present invention provides a combination of gateway device 14 and mass storage device 26 located on, for example, an external PC. Gateway device 14 and storage device 26 are preferably connected through an HPNA or a similar type of interface 22. The advantages include reduced cost to the manufacturer and consumer of the gateway device and increased possibilities to customize data and applications to an individual customer's setup. This is accomplished using an HPNA or a similar type of interface with sufficient bandwidth to provide efficient performance, e.g., 20 Mb/s or greater bit rate. Encryption and copy protection techniques must be implemented on the data sent and stored through the system to ensure security issues are dealt with satisfactory.

A network control system (NCS) 50 may be provided as part of the data provider's network 52. Network 52 may be a DSL network, a cable network or any other network. In one embodiment, NCS 50 manages the content in the storage device 26. NCS 50 includes a management entity 54 that takes care of pushing content to memory storage 26 pursuant to subscriber orders, and deleting content from storage 26. NCS 50 or gateway 14 provide a termination point for the signaling that controls the access to the content on storage 26 by setting up and tearing down virtual circuits based on users access rights and requests. In addition, NCS 50 or gateway 14 also provides functions for permitting a customer to control the content flow, e.g., functions such as pause, stop, play, advance, reverse, etc. of the content may be controlled by a user in much the same way as traditional VCR functionalities. NCS 50 also provides information on customer activity for billing purposes.

An output device 56 is coupled to gateway device 14. Output device 56 employs a data stream stored on storage device 26 or directly sent from network 52 through gateway device 14. Output device 56 may include a television a personal computer, a display or any other device, which can employ data received over a network. In one embodiment, storage device 26 functions as a buffer to adjust bandwidth requirements of the system during viewing of a video stream, for example.

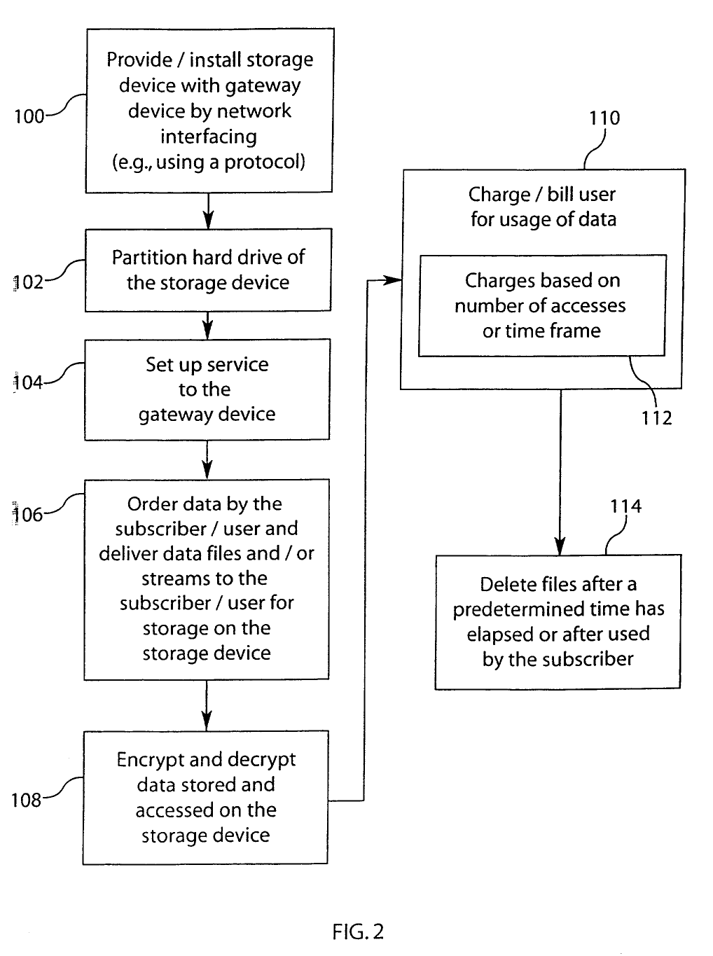

Referring to FIG. 2, a flow diagram is shown depicting a method for employing a mass storage system in conjunction with a gateway device in accordance with the present invention. In block 100, a gateway device is installed and connected to a PC or other memory storage system. A connection may be made with an interface, such as an HPNA interface. A partition is set up on the storage system with limited access to the partitioned space by a user, in block 102. In block 104, service is set up between the gateway device and the data provider. The data provider may be a cable company, a telephone company or any other purveyor of data content. Once a connection is established, data may be downloaded on demand or on a delay depending on the capabilities of the gateway device and the data provider's system. In a video-on-demand system, videos of files may be ordered and shipped to an end users gateway device in block 106.

In block 108, if not already encrypted from the data provider, the data received by the gateway device is encrypted and stored on the mass storage device. The gateway device includes a key or code, which is used in decrypting the video or data stream. The video or data stream is therefore only useable in with the gateway device. The gateway device has limited access to memory storage device in the partitioned area only, and the user does not have access to this partitioned area, the user can only access the video or data file through the gateway device. In addition, since the file is encrypted, even if a user can access the file, the file cannot be used without the gateway device.

Since the gateway device controls access and usage of the file, the user can be appropriately billed for access and/or usage of the specific file, in block 110. In addition, the user is prevented from unauthorized copying or usage of the video or data file. In block 112, the user can be charged based on usage (e.g., number of viewings of a video or number of accesses of the video) or unlimited access for a given period of time (e.g., for a day a week, etc.). In block 114, the gateway device automatically deletes the file after the file has been viewed or after a predetermined amount of time.

Having described preferred embodiments for broadband set-top box front-end storage system (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A user-side receiver system, comprising:
a gateway for providing a link between a network that carries content and an output device; and
an interface coupling the gateway to an external storage device for storage of content on the external storage device such that access to the stored content is controlled via the gateways.

2. The receiver system as recited in claim 1, wherein the gateway device includes a set-top box.

3. The receiver system as recited in claim 1, wherein the storage system includes a personal computer.

4. The receiver system as recited in claim 3, wherein the personal computer is maintained and operated by the user.

5. The receiver system as recited in claim 3, wherein the personal computer includes a partition, which is accessible only through the gateway device.

6. The receiver system as recited in claim 3, wherein the personal computer includes other uses by the user.

7. The receiver system as recited in claim 1, wherein the storage system includes an operating system compatible with the gateway device.

8. The receiver system as recited in claim 1, wherein data received from the network is compatible with the operating system of the storage system.

9. The receiver system as recited in claim 1, wherein the storage system stores encrypted data and the gateway device includes decryption codes for decrypting the encrypted data.

10. The receiver system as recited in claim 1, wherein the network interface includes a home phoneline network alliance interface.

11. A method for receiving and storing data from a subscriber-based network, comprising the steps of:
providing a gateway device between a subscriber-based network and an output device;
coupling a storage system to the gateway device for providing memory for storage of data streams transmitted from the network to the gateway device, said storage system being external to the gateway device;
interfacing the gateway device to the storage system with a networking protocol;
receiving a data stream through the gateway device from the subscriberbased network; and
storing the data stream on the storage system.

12. The method as recited in claim 11, wherein the step of providing a gateway device includes the step of providing a set-top box for the gateway device and providing a personal computer for the storage system.

13. The method as recited in claim 12, further comprising the step of forming a partition on the personal computer, which is accessible only through the gateway device.

14. The method as recited in claim 11, wherein the step of interfacing the gateway device includes employing a home phoneline network alliance interface.

15. The method as recited in claim 11, wherein the step of storing includes storing encrypted data wherein the gateway device includes decryption codes for decrypting the encrypted data.

16. The method as recited in claim 11, further comprising the step of charging a user for accessing data stored by the storage system.

17. The method as recited in claim 16, wherein the step of charging a user for accessing data stored by the storage system includes charging on a per access basis.

18. The method as recited in claim 16, further comprising the step of deleting the data stored by the storage system after a predetermined amount of time.
